(19) United States
(12) Patent Application Publication
(10) Pub. No.: US 2012/0195431 A1
(43) Pub. Date: Aug. 2, 2012

(54) METHOD FOR OPERATING A NODE IN A WIRELESS SENSOR NETWORK

(75) Inventors: Oscar Garcia Morchon, Eindhoven (NL); Heribert Baldus, Eindhoven (NL); Klaus Kursawe, Eindhoven (NL)

(73) Assignee: KONINKLIJKE PHILIPS ELECTRONICS N.V., EINDHOVEN (NL)

(21) Appl. No.: 13/499,930

(22) PCT Filed: Oct. 7, 2010
(86) PCT No.: PCT/IB2010/054536

§ 371 Date: Apr. 3, 2012

(30) Foreign Application Priority Data
Oct. 14, 2009 (EP) 09305981.4
Jan. 7, 2010 (EP) 10305018.3

(51) Int. Cl. H04K 1/00

(52) U.S. Cl. 380/270

(57) ABSTRACT

The present invention relates to a method for operating a first node in a network, the network including a plurality of nodes, the method comprising (a) the first node having a first identifier joining the network by transmitting the first identifier to a second node having a second identifier, (b) the first node generating a first key on the basis of the second identifier (c) the first node authenticating the second node by means of the first key, (d) the first node communicating with a third node if the first and second keys are equal.

### FIELD OF THE INVENTION

The present invention relates to a method for operating a node in a network, in particular in a wireless sensor network.

This invention is, for example, relevant for Zigbee networks, or for sensor networks being ad hoc networks and where the nodes are usually resource constrained.

### BACKGROUND OF THE INVENTION

Wireless sensor networks (WSNs) may comprise thousands of resource-constrained (energy, CPU, etc) sensors and actuators communicating through wireless links. Routing protocols are used to exchange information between a number of nodes. Security protocols are used to bootstrap security and ensure basic security services.

ZigBee, ZigBee IP and 6LoWPAN networks are examples of such WSNs. ZigBee uses an AODV (Ad hoc On demand Distance Vector)-based routing protocol and a centralized security architecture for the distribution of keys. Indeed, in a Zigbee network, a Trust Center may distribute the encryption keys to be used in the network. 6LoWPAN runs on the top of IEEE 802.15.4 IPv6 complaint protocols for routing. In this context, the management of the addresses needed for neighbour discovery, route discovery etc., is cumbersome. The use of traditional security primitives is unfeasible on resource-constrained devices regarding the security architecture.

A first problem in such networks refers to the non-secure neighbour discovery and routing protocol. In an exemplary network 100 illustrated on FIG. 1A, when a node 101 (e.g. a ZigBee end-device) joins a ZigBee network for first time, the node 101 looks for routers 102-103 from which the node 101 receives an address to be used in the network. However, at this time the node 101 does not have any keying material at all so that this association is not secure. For instance, an attacker 104 might play the role of a “good” router and distribute a completely wrong address/information to the joining device 101. Even if the ZigBee Network key was used for authentication, the system would still be prone to attacks as the key is not linked to any identifier and the attacker might simulate several identities.

A second issue is sensor networks such as ZigBee refers to the protocol overhead for routing and security. In a traditional scenario illustrated on FIG. 1B in the same network 100, the node 101 first looks for neighbours, then the node 101 wishing to communicate with another node 109 starts the routing protocol (e.g., AODV). Once the route has been established by contacting nodes 105, 106, 107 and 108, both nodes 101 and 109 can run a security handshake, e.g., for key agreement and authentication, and finally they can exchange information. Obviously, this approach is not only not secure (due to the non-secure neighbour discovery, and non secure route discovery through a number of nodes) but also non-energy efficient.

### SUMMARY OF THE INVENTION

It is an object of the invention to propose a method for operating a network offering a secure mechanism for the nodes joining the network.

It is another object of the invention to propose a method for operating a network with a route discovery which is efficient but secure.

It is still another object of the present invention to alleviate some of the above problems.

This invention addresses a number of issues related to security and routing in wireless sensor networks whose main goal is to improve the performance (energy consumption) and system operation (latency, delays, security) by means of cross-layer optimization techniques between routing and security.

To this end, in accordance with a first aspect of the invention, a method is proposed for operating a first node in a network, the network including a plurality of nodes, the method comprising
(a) the first node having a first identifier joining the network by transmitting the first identifier to a second node having a second identifier,
(b) the first node generating a first key on the basis of the second identifier
(c) the first node authenticating the second node by means of the first key,
(d) the first node communicating with a third node if the first and second keys are equal.

In accordance with a second aspect of the invention, a method is proposed for operating a network, the network including a plurality of nodes, the method comprising

(a) a first node, having a first identifier, joining the network by transmitting the first identifier to a second node having a second identifier,

(b1) the first node generating a first key on the basis of the second identifier,

(b2) the second node generating a second key on the basis of the first identifier,

(c) the second node authenticating the first node by means of the second key,

(d) the first node communicating with a third node if the first and second keys are equal.

In accordance with a third aspect of the invention, independent or in combination of the first and second aspects of the invention, a method is proposed for operating a network, the network including a plurality of nodes, the method comprising (c′) the first node discovering a route to the third node,

wherein the third node comprises a third identifier, wherein the network is a multihop network and wherein step (c′) comprises

(c′1) the first node transmitting to first neighboring nodes in the vicinity of the first node a route request for discovering a route to the third node, the route request including the address of the third node and an encrypted first route verification message, the encrypted first route verification message being encrypted with a third key generated by the first node on the basis of the third identifier.

In accordance with a fourth aspect of the invention, it is proposed a node having a first identifier and comprising a transceiver for communicating in a network,

the transceiver being adapted for joining the network by transmitting the first identifier to a second node having a second identifier,

for receiving an authentication message encrypted with a second key generated by the second node on the basis of the first identifier,

the node further comprising a key generator adapted for generating a first key on the basis of the second identifier

and control means for comparing the first and the second keys with the authentication message,

the transceiver being adapted for communicating with a third node if the first and second keys are equal.

As a consequence, the two main advantages of this approach are secure neighbour discovery, energy-system operation as no-messages are needed to be exchanged for key agreement, and a simplified addressing scheme that reduces the amount of information to be stored, processed, and exchanged.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIGS. 1A and 1B, already described are block diagrams of a conventional network;

FIG. 2 is a flow chart representing the routing mechanism in a conventional network.

FIG. 3 is a block diagram of a network in accordance with a first embodiment of the invention.

FIG. 4 is a flow chart showing a method for operating the network in accordance with the first embodiment of the invention.

FIG. 5 is a flow chart showing a method for operating the network in accordance with the third aspect of the invention.

FIGS. 6A-6D show the content of a route discovery message in an example of the third aspect of the invention.

FIGS. 7A-7D show the content of a route reply message in an example of the third aspect of the invention.

### DETAILED DESCRIPTION OF THE INVENTION

This invention describes a cross-layer optimization between security and routing protocols to overcome above drawbacks. The main idea relies on the use of an ID-based cryptography scheme for key agreement, and the use of the routing addresses as crypto identifiers.

ID-based cryptography allows for key agreement and/or authentication based on some keying material and the identifier assigned to a node. In this description, the main approach uses an ID-based cryptosystem based on polynomials. It is to be noted that there are also other types of ID-based cryptosystems based on, e.g., public-key cryptography or other key generators using the routing address as a seed.

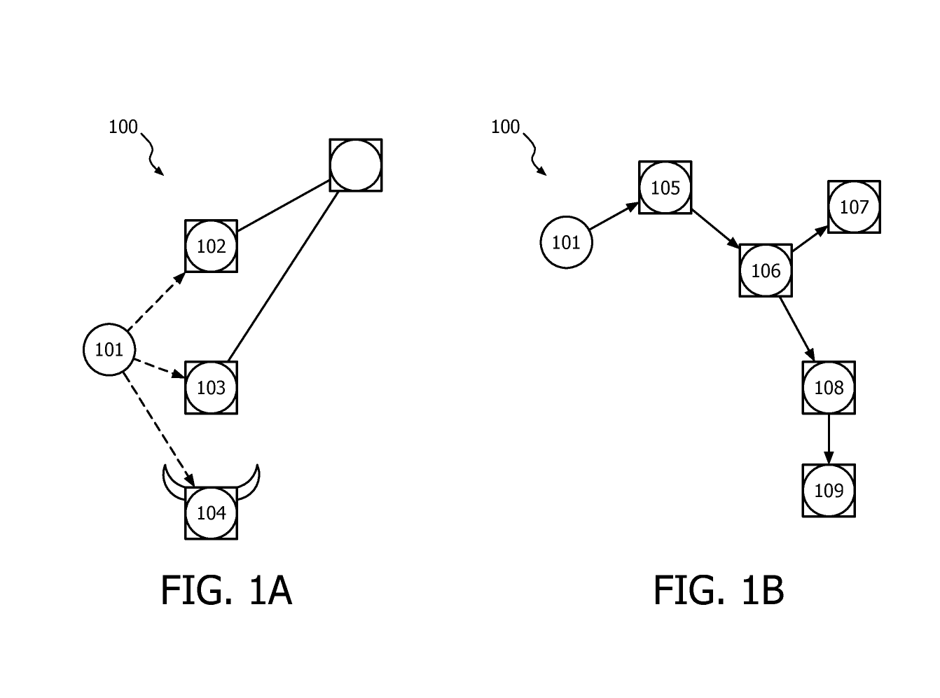

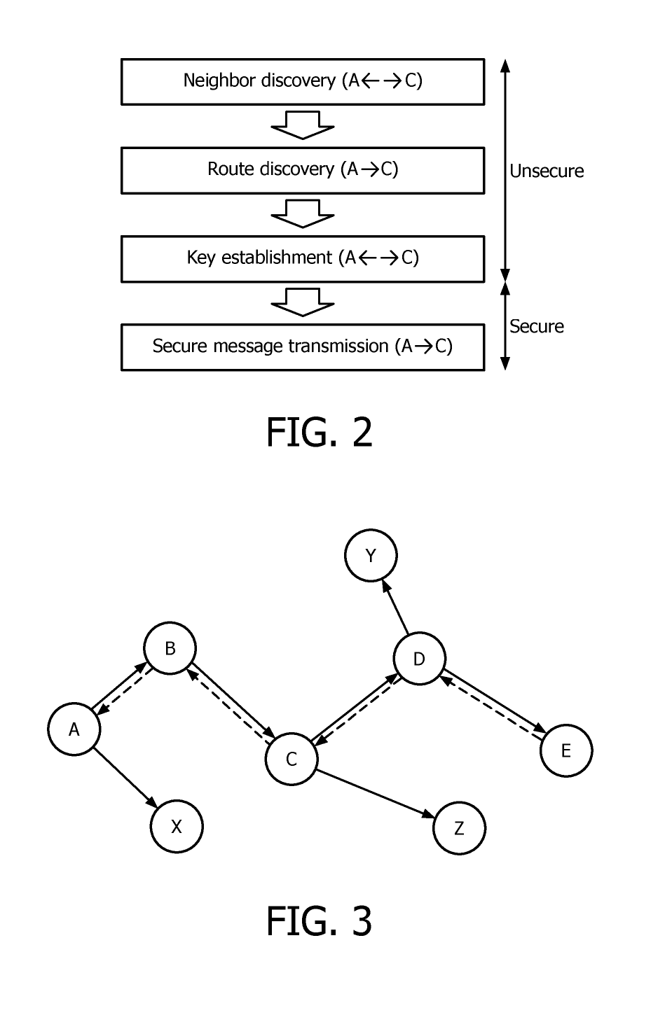

In a conventional system as those described in relation with FIGS. 1A and 1B, the joining of an end device and the route discovery are operated in accordance with the flow chart of FIG. 2. This operation will be described in a Zigbee network where a ZigBee-IP network is a sub-net connected to the Internet via a (or several) Gateway(s). Each node in the network gets a fixed IP-address. It will be assumes that the sub-net size is limited to 2¹⁶ devices matching the maximum size of a ZigBee network. Only the last 16 bits of the IP addresses in the same sub-net change. Each device in the network receives a polynomial share linked to the last 16 bits of its IP-address. The polynomial shares are generated from root keying material generated by a trust center not represented on FIG. 1A or 1B of the ZigBee-IP sub-net. Thus, any device in the network can generate a pairwise key with any other device by evaluating its polynomial share in the last 16 bits of the IP-address of the other device. The same may apply with other keying material than bivariate symmetric polynomials.

As shown on FIG. 2, the operation is not secured until the key establishment for communicating with the node C being node 109 on FIG. 1. It means that the neighbor discovery as shown on FIG. 1A and the route discovery as shown on FIG. 1B are not secured, although they imply contacting a high number of nodes, multiplying thus the chances of facing an attacker. Thus, there is a risk of seeing the node A (101 on FIGS. 1A and 1B) being attacked and corrupted by node 104 for instance.

As a consequence, it is proposed in a first embodiment to reduce the risk of attack. FIG. 3 represents a network in which this embodiment is implemented. In this network, the node A joins the network, which comprises nodes B, C, D, E, X, Y, and Z. For communicating from a node to another, it is required to have a hop communication relayed by intermediate nodes. For instance, for communicating from node A to node C, it is required that node B relays this communication. Upon joining the network, the node A may first need to carry out a node discovery, i.e. node A broadcasts a message indicative of the wish to join the network. Nodes B and X receives such a message and may send an authentication message encrypted with a key based on node A identifier. Here the identifier is the routing address.

Similarly, the node A may send an authentication message to one or all nodes that replied to the discovery. This authentication message is encrypted with a key based on the respective identifier of node B and node X. Here the node A uses its keying material. This keying material may be present in the node A in accordance with several possibilities or obtained from a trust center in the network.

It might be that in a previous work the node A already has the keying material when it joins the network. It is also possible that the system configuration is such that the nodes are configured with keying material. This might happen offline or online. It is also possible, after node deployment, that the system operates in a secure manner as described in the below embodiments. It is also possible that the network nodes are configured without any keying material. Then, the network nodes are deployed and the system starts operating. The nodes form a non-secure network at time zero. During this first configuration step, the nodes receive keying material from the network coordinator. The keying material is linked to a crypto-identifier as described in the below embodiment. Eventually, normal system operation during which the network operates in a secure manner as described in the below embodiment.

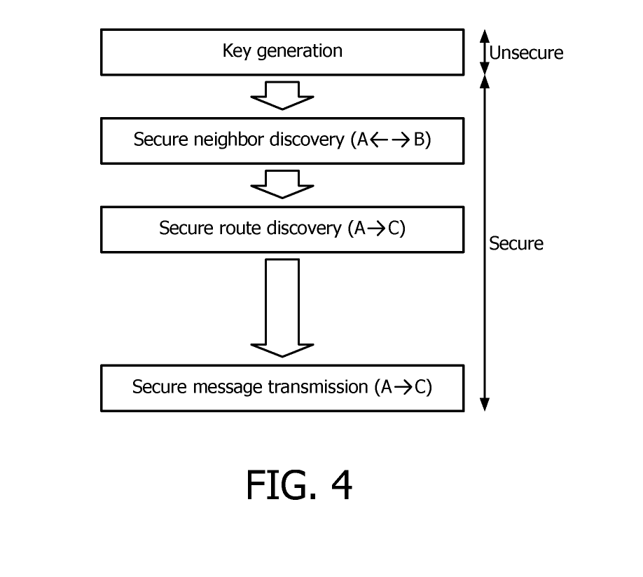

This first embodiment is represented on FIG. 4. It may be done as follows:
Initial setting: in this example, each node receives a secret polynomial keying material such as a polynomial in one variable F(ID,y) (mod q) over a finite field GF(q) with identifier ID. These polynomials in one variable are generated from a symmetric polynomial F(x,y) (mod q). Moreover, each node receives a different identifier ID during setup and the identifier ID is used as routing address.
In operation as shown on FIG. 4: the system operation comprises three main steps
Step 1: Secure neighbor discovery: a node joins the network by looking for neighbors. When a node A finds a neighbor B or X, node A uses its polynomial share F(A,y)(mod q) to generate a pairwise secret with B by evaluating its polynomial in y=B. B does the same. Due to the symmetry of the system, both nodes generate the same key and can run an authentication protocol. If this is successful, then A has verify the identity of B (thus, we allow for secure joining) and B has verified that A is allowed to join.

In order A to be able to verify that node B is actually its neighbor with high accuracy and that the node is not located further away, node A requires the handshake to occur within a period of time T where T is the reference time to carry the authentication handshake. In this way, an attacker acting as relay between two honest nodes would introduce a delay D so that the overall handshake time will be T+D, and he would, therefore, fail in his attempt of subverting the network operation.
Step 2: route discovery: once node A has joined the network, node A starts the routing protocol to send a message to a third node E.

This step comprises node A broadcasting (i.e. transmitting to any neighboring nodes in its vicinity) a route request for discovering a route to the node E. The route request includes the Identifier or the address of the node E. Moreover, as will be explained in further details in another embodiment of the invention, the route request may comprise a message encrypted with a key generated by the node A on the basis of the identifier of node E. This message may be the mere route request codeword, or any other convenient codeword, as soon as it is known from each party.
Step 3: Secure message transmission: Finally, node A uses its polynomial share to generate a key with E. This key is generated as F(A, y=E)(mod q) and used to encrypt the message to be transmitted. In this way, the message can be transmitted directly without requiring a key establishment handshake. This message may be transmitted with the identifier of the node A.

From this, it is clear that the exchanges are secure really early in the process, especially when compared with the method represented on FIG. 1 so that node E is able to generate a key with the identifier of node A and decrypt the message.

It is also possible to have the following variations.
Use of other ID-based systems such as public-key based crypto.
Use of other polynomial-structures for the keying material that make the system more resilient to node capture.

In accordance with another embodiment of the invention, it will be examined how the route discovery can be made more secure. Cross-layer optimization is a key feature for distributed wireless sensor networks as it allows reducing the overall resource-requirements and offering new capabilities.

As a reactive ad hoc routing protocol in a conventional network, DYMO includes two protocol operations: route discovery and route maintenance. Routes are discovered on-demand when a node needs to send a packet to a destination currently not in its routing table. A route request message is flooded in the network using broadcast and if the packet reaches its destination, a reply message is sent back containing the discovered, accumulated path. Each node maintains a routing table with information about nodes. Each entity may comprise (i) destination address, (ii) sequence number, (iii) hop count, (iv) next hop address, (v) next hop interface, (vi) its gateway, (vii) prefix, (viii) valid timeout, and (ix) delete timeout.

In an exemplary route discovery handshake; the originator node sends a Route Request (RREQ) and awaits the reception of a Route Response (RREP) message from the target. The waiting time is controlled by an additional parameter RREQ_WAIT_TIME. When a node receives a RREQ packet, the node updates its routing tables if needed. If the originator entry in the RREQ is found to be, e.g., stale, the RREQ is dropped. If not, each node processing an RREQ can create reverse routes to all the nodes for which addresses are accumulated in the RREQ. When the RREQ reaches the destination, it processes the packet and uses the information accumulated in the RREQ to add route table entries. An RREP message is then created as a response to the REEQ, containing information about the target node (address, sequence number, prefix, etc). Since replies are sent on the reverse path, DYMO does not support asymmetric links. The packet processing done by nodes forwarding the RREP is identical to the processing that nodes forwarding an RREQ perform, i.e., the information found in the RREP can be used to create forward routes to nodes that have added their address blocks to the RREP.

Routing protocols are prone to many different kind of attacks including spoofed, altered, or replayed routing information, selective forwarding, Sinkhole attacks, the Sybil attack, Wormhole attacks, the HELLO flood attack, or acknowledgement spoofing. Protecting the system against those threats is challenging as the attack might come from insiders or outsiders, furthermore we might find laptop-class attackers that are much more powerful than mote-class attackers. In this context, the system should be able to avoid those attackers in the presence of outsider attackers. However, if insider attackers are involved in the attack, the best we can hope is graceful degradation, i.e., the effectiveness of the routing protocol should degrade no faster than a rate approximately proportional to the ratio of compromised nodes to the total nodes in the network.

The security architecture of IPSec comprises the Internet Key Exchange (IKE) for security association and key agreement, the Authentication Header (AU) for connectionless integrity, origin authentication, and reply protection, and the Encapsulating Security Payload (ESP) for confidentiality, origin authentication, and connectionless integrity. Additionally, IPSec includes two different modes of operation. The first one, the transport mode, allows delivering traffic end-to-end between networks and within the same network. The second one, tunnel mode ensure secure transmission through an insecure network.

Therefore, ensuring effective and practicable security in such networks requires finding an approach offering a trade-off between the provided (and required) security services—data confidentiality, data authentication, data integrity, data freshness, availability, robustness, resiliency, resistance, energy efficiency, and assurance—and the security challenges such as minimizing resource consumption or enduring a big range of interfering,

The main idea of this embodiment is the combination of the polynomial approach based on the deterministic segment diversification scheme implemented on the MSP430 and the routing protocol used in 6LoWPAN to allow for host-to-host security without requiring a key establishment handshake. In other words, it is aimed at converting a routing protocol such as DYMO into a secure routing protocol.

It is to be noted that the above polynomial-scheme is an identity-based cryptographic protocol, i.e., it allows a party A to generate a pairwise key with B given the identity of the target node B. This nicely fits into the secure host-to-host operation of related routing protocols such as 6LoWPAN.

According to these concepts, this cross-layer optimization involves the modification of the operation of IPSec for 6LoWPAN networks in such a way that DSD is used for key distribution and establishment and IEEE 802.15.4 security to ensure basice security services. When two nodes want to communicate with each other, they do NOT launch the IKE, but use the DSD to establish a pairwise key with the other party. This key is used to protect the information by means of 1.5.4 security instead of ESP. The approach does not include any mechanism as AU. Furthermore, we integrate these changes in the 6LoWPAN routing protocol so that phases such as neighbor discovery or the update of the routing tables become secure.

The comparison between FIGS. 2 and 4 shows the main differences between a traditional approach and the proposed concept. In a conventional scheme, routing and key establishment run at different phases. In first place, the route between two nodes A and B is discovered by means of a traditional routing protocol, e.g., DYMO. Afterwards, a key establishment handshake can be carried out to generate a common secret between A and B. This has two main drawbacks. First, the routing protocol itself is not secure. Second, additional messages need to be exchanged to generate the key. It is thus proposed in connection with the embodiment of the invention to merge these two steps into one to achieve a secure routing protocol removing the need for the key establishment handshake. This is explained in the following section.

ID-based cryptography can be used allow for secure routing protocols and efficient cross-layer optimizations between security and routing. We apply this concept to the DYMO protocol.

It is proposed to make the following design decisions linked to the exemplary embodiment of a sensor network:
Each routing address is used as DSD cryptoidentifier. We use the last 16 bits of an IP address, either IPv4 or IPv6 as the DSD crypto-ids. Note that this restriction is due to the use of small finite fields over GF(2¹⁶+1). It is to be noted also that in this still allows for sub-nets with up to 65636 sensor nodes.
the IP addresses, and thus the crypto-IDs, are fixed.
the deterministic segment diversification approach as the ID-based crypto-system.

The operation of the DYMO protocol is adapted in combination with the DSD to operate in a secure way in the sense that (i) in each step the parties can verify the authenticity of the peers, and (ii) the end-hosts can verify the identities of the nodes in the route. Furthermore, we remove the need of a key establishment handshake reducing the communication overhead.

As seen in the first embodiment, before starting any route discovery, a node needs to know which nodes are in its close vicinity. This phase of the secure DYMO protocol follows the next steps:

1. Node A sends a broadcast message Neighbor Request including its address A.

2. A's Neighbors reply including their addresses. A creates a list of non-verified neighbors (LNVNs)

3. A's proceeds to verify the neighbors in the LNVNs by:

a. Generating a pairwise key with each of them based on the other peer's address and its own DSD keying material

b. Launching a mutual-authentication handshake with each of its neighbors

4. The nodes in the LNVNs for which the authentication handshake is successful are stored in the list of verified neighbors (LVNs)

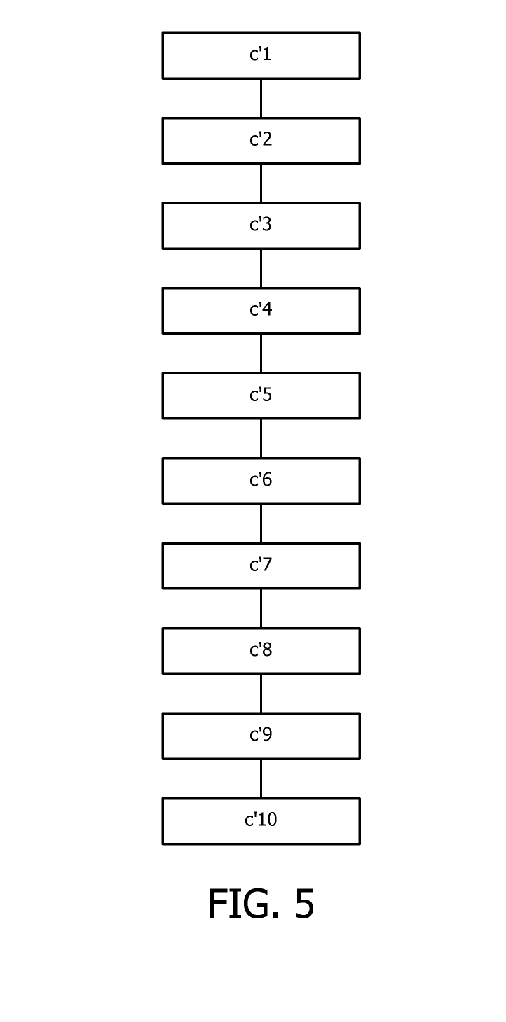

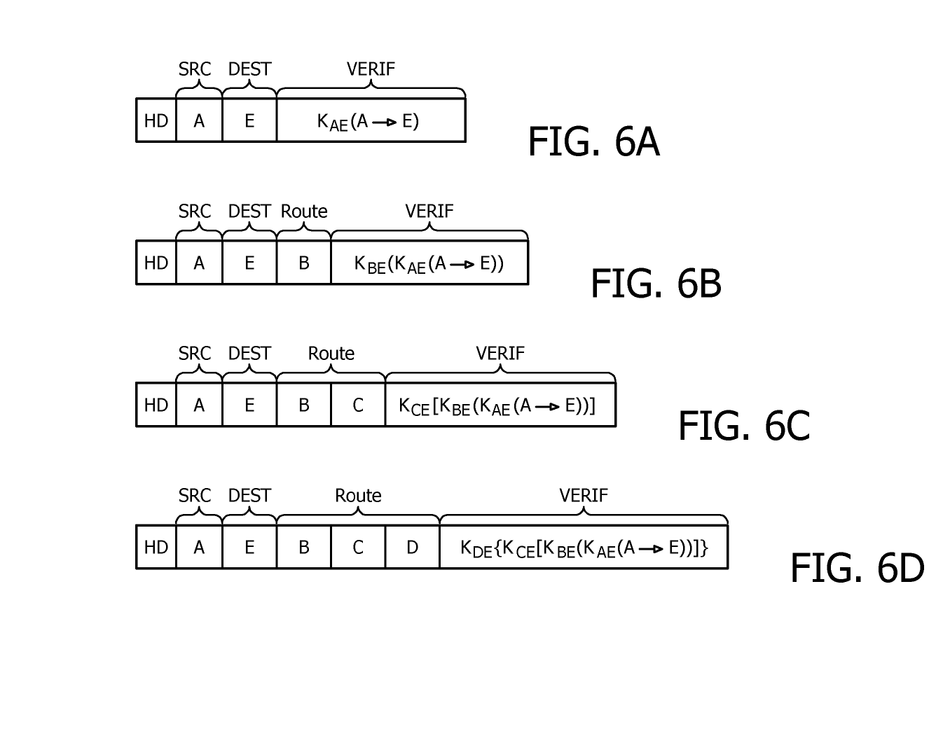

Regarding the route discovery, it will be explained in connection with FIGS. 5, 6A-D and 7A-D.

A route request message is flooded in the network using broadcast to connect node A with node E over a route {B, C, D}. The route request message includes information to verify the discovered route. This information is built hop-by-hop. At stage 0, or step c′1 on FIG. 5, this information comprises the values {A→B, N0=EK_AB{A→B}} where A→B refers to the route to be discovered and N0=EK_AB{A→B} is the route verification information at stage 0, i.e, the route to be discovered encrypted by the pairwise key between A and B (noted K_AB or K_{AB} on FIG. 6A) generated by means of the DSD algorithm at A or B given the address of B or A respectively.

When a node B receives a SRREQ packet, comprising a header (HD), the source (SRC being A), the destination (DEST (being E), the node updates its routing tables if needed. If the originator entry in the SRREQ is found to be, e.g., stale, the SRREQ is dropped. If not, each node processing an SRREQ can create reverse routes to all the nodes for which addresses are accumulated in the SRREQ. Node B encrypts the route verification information at stage 0 with its pairwise key with the destination B, as shown on FIG. 6B. Furthermore, Node B adds its address to the generated route broadcasting in the ROUTE field.

The same is applied for the subsequent nodes C and D, as shown on FIGS. 6D and 6D. Each time the verification message (field VERIF) may be replaced in the next relayed route request message by the encryption of this verification message by means of the key obtained by the node when applied on the destination node identifier.

When the SRREQ reaches the destination E, node E processes the packet and uses the information accumulated in the SRREQ ROUTE filed to add route table entries. Node E can also verify the validity of the route by decrypting the given received route with the corresponding pairwise keys generated by means of the DSD.

Thus, Node E can verify the validity of the route and detect as well where in the route there might be a corrupted node.

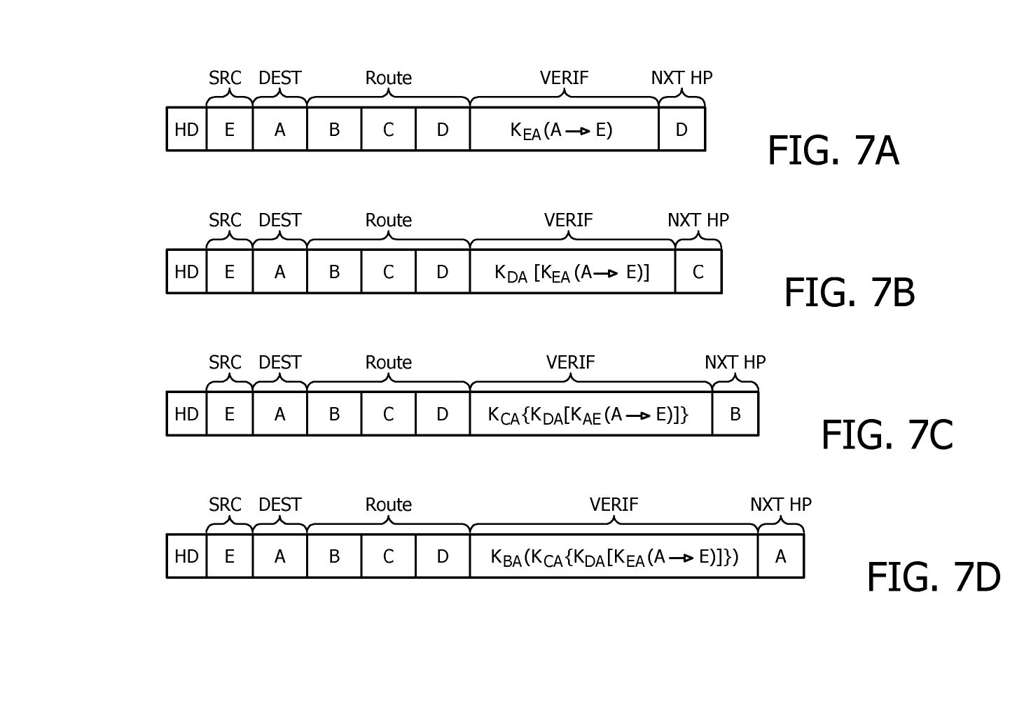

As can be shown on FIGS. 7a to 7D, the route discovery reply, or Secure RREP (SRREP), operates almost like SRREQ but in reverse order. At stage 0, SRREQ includes the confirmation of the route as shown on FIG. 7A. Each intermediate node B, C, D encrypts the route verification information with the pairwise key with the destination A. Each node does not need to broadcast but securely unicast the packet to the next node in the route with the pairwise keys established during the neighbor discovery phase. The destination A of the SRREP can verify the route by generating the pairwise keys with the nodes in the route by means of the DSD algorithm and performing N+1 (here 4) decryption operations on the verification information.

After reception of SRREP, node A can transmit messages to node E through the discovered route by using key K_{AE} to secure the communication link.

The system can be easily adapted to even provide for more advanced features. One of them refers to the session keys, which are used to protect the long term secrets generated from the polynomial keying material by means of the DSD, can be easily generated by including two nonces RN0 and RM0 in N0 and M0, i.e., N0=K_AE{A→E, RN0} and M0=K_EA{E→A, RM0}. Nodes E and A generate the common link key after receiving SRREQ and SRREP respectively as hash(KAB∥RN0∥RM0) where hash( ) refers to a secure one-way hash function.

SDYMO includes an approach to verify the identities of neighboring nodes. This approach fails if an attacker makes use of a high range antenna as the attacker can directly communicate even with those nodes located in distant places. The approach also fails if the attacker replicates the node. This can be solved from the network point of view by looking for collisions in the LVNs of different nodes. The main idea here is that two good nodes in distant locations are going to share a same compromised neighbor with very high probability, and thus, those nodes can be removed from the network in a probabilistic manner.

To this end, the encryption function Mᵢ=E_{K-IDiA} {Mᵢ₋₁} is substituted by Mᵢ=E_{K-IDiA} {LVNᵢ|Mᵢ₋₁} (note that the encryption function can represent any cryptographic block) and the LVNi is attached to the message. Both the sender and verifier will be able to verify the claims of the routers regarding their LVNs. If an attacker has captured a node with identity ID and deployed copies of the node in different locations of the network, a same node (and identity) will appear in the LVNs of nodes in different places. This allows the verifiers to decrease the trust level with that node.

SSYMO allows for secure routing between two parties by applying a more efficient approach based on id-based crypto. We consider three main advantages: (i) the use of the identifiers as addresses allows sender and receiver to verify that the actual end is the good one; (ii) each node in the path has to encrypt the message with it's pairwise key with receiver or sender in the SRREQ or SSREP respectively, so that both receiver and sender can verify the path; (iii) finally, the SRREQ uses unsecure broadcast, but SSREP requires secure unicast so that the nodes in the path can also verify that they forwarded packets belong to nodes in the network.

These features allow us to achieve similar security features than related secure routing protocols but in a more efficient way. Specially, the SSYMO protocol prevents attackers from launching the Sybil attack as each node has a unique identifier and mutual authentication can be performed. Here, we assume that if a node is compromised and an attacker uses the same identity/keying material in different locations, the compromised device can be discovered and a revocation message against the devices sent to the network. Protection against fancier attacks such as HELLO flood or WormHole attacks might be possible at the price of establishing additional measures. For instance, HELLO flood attacks might be avoided by exchanging the x first elements of the LVNs tables between y-hop neighbors. If a number of nodes with completely different LVN find that a same id is in their LVN, that node would be a candidate for being guilty of a HELLO flood attack. Note that such collisions are very probable due to the Birthday paradox.

The described approach presents a number of advantages. The energy requirements are much lower as key agreement requires a very low amount of CPU resources and communication is not needed at all as key agreement is based on an identity-based cryptosystem. Delays are minimized in the same manner. Secure route discovery requires n+1 key generation operations and 2(n+1) encryption/decryption handshakes where n refers to the number of hops between two hosts. This can be implemented in a very efficient way due to the low-resource requirements of the DSD and the AES-coprocessor available on the CC2420. Furthermore, the changes required in the original DYMO routing protocol used in 6LoWPAN are minimum. Consequently, the system can be easily updated.

This invention has been developed in the framework of the FP6 WASP EU project. The system can be used by the WASP project or other partners of the WASP project.

FIG. 5 summarizes the steps of the above explained method.

In this process of discovering a route from node A to node E, it is possible to have the following steps.

(c′1) node A broadcast to its neighboring nodes B and X a route request for discovering a route to node E. The route request including the address of node E (DEST) and an encrypted first route verification message (VERIF). The encrypted first route verification message is encrypted with a key generated K_{AE} by node A on the basis of the identifier node E.

(c′2) when node B receives the route request from node A, node B generates an encrypted second route verification message VERIF, the encrypted second route verification message being encrypted with a key K_{BE} generated by the node B on the basis of the identifier of node E. Node B broadcasts (relays) the route request to second neighboring nodes C in the vicinity of the node B. However, the route request is modified to include the second route verification message in the field VERIF.

The encrypted second route verification message is the result of the encryption, by means of the key K_{BE}, of the encrypted first route verification message. Node B replaces the first route verification message by the second route verification message in the route request. (c′2) may also comprise node B adding its identifier in the subsequent route request in the ROUTE field.

(c′3) node E receives the route request from node D (intermediate nodes have been skipped for the sake of conciseness)

(c′4) and (c′5) node E decrypts the codeword in the VERIF field by means of itartive decryption with keys K_{ED}, K_{ED}, K_{EB} and K_{EA}.

(c′6) node E generates an encrypted first route reply verification message, the encrypted first route reply verification message being encrypted with key K_{EA}, and node E transmits a route discovery reply comprising a description of the route from node A to node E and the first route reply verification message.

(c′7) node B receives the route discovery reply, and generates an encrypted second route reply verification message, the encrypted second route verification message being encrypted with key K_{BA}. Then, node B transmits to node A the route discovery reply, the route discovery reply being modified to include the second route reply verification message.

(c′8) Node A receives the route discovery reply,

(c′9) and (c′10) Node A decrypts the codeword in the VERIF field by means of itartive decryption with keys K_{AB}, K_{AC}, K_{AD} and K_{AE}.

Other application areas include distributed systems, and sensor networks, and communication networks.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of radio communication.

1. A method for operating a first node in a network, the network including a plurality of nodes, the method comprising:
joining the network, by the first node having a first identifier, by transmitting the first identifier to a second node having a second identifier,
generating, by the first node, a first key on the basis of the second identifier
authenticating, by the first node, the second node based on the first key, and
communicating, by the first node, with a third node if the first and second keys are equal.

2. The method of claim 1, further comprising the first node discovering a route to the third node prior to communicating with the third node.

3. The method of claim 2, further comprising the first node verifying the actual position of the node based on communication delay due to the communication medium, hardware, or software.

4. The method of claim 2, wherein the third node comprises a third identifier, wherein the network is a multihop network and wherein the first node transmits to neighboring nodes a route request for discovering a route to the third node, the route request including the address of the third node and a route request message encrypted with a third key generated by the first node on the basis of the third identifier.

5. The method of claim 1, further comprising
generating a third key on the basis of the identifier of the third node and
ciphering a first message based on the third key for transmitting a ciphered message to the third node for initiating communication.

6. The method of claim 5, wherein the first node transmits the ciphered message along with the first identifier.

7. The method of claim 1, wherein the first key and the third key are generated from a first polynomial keying material obtained by estimating a polynomial keying root with two variables with the first identifier as one of the two variables.

8. The method of claim 7, wherein the first polynomial keying material is received by the first node from a trust center.

9. The method of claim 1 wherein the first, second, and third identifiers are respective routing addresses of the first, second, and third nodes.

10. A network including a plurality of nodes, comprising:
a first node, having a first identifier, joining the network by transmitting the first identifier to a second node having a second identifier,
the first node generating a first key on the basis of the second identifier,
the second node generating a second key on the basis of the first identifier,
the second node authenticating the first node based on the second key, and
the first node communicating with a third node if the first and second keys are equal.

11. The network of claim 10, further comprising the first node discovering a route to the third node.

12. The network of claim 11, wherein the third node comprises a third identifier, wherein the network is a multihop network and wherein
the first node transmits to first neighboring nodes in the vicinity the first node a route request for discovering a route to the third node, the route request including the address of the third node and an encrypted first route verification message, the encrypted first route verification message being encrypted with a third key generated by the first node on the basis of the third identifier.

13. The network of claim 12, wherein
the second node receives the route request from the first node, the second node generating an encrypted second route verification message, the encrypted second route verification message being encrypted with a fourth key generated by the second node on the basis of the third identifier, and broadcasting to second neighboring nodes in the vicinity of the second node the route request, the route request being modified to include the second route verification message.

14. The network of claim 13, wherein the encrypted second route verification message is the result of the encryption, based on the fourth key, of the encrypted first route verification message, and wherein the second node replaces the first route verification message by the second route verification message in the route request.

15. The network of claim 13, wherein
the second node adds the second identifier in the subsequent route request.

16. The network of claim 12, wherein
the third node receives the route request, and
the third node decrypts the encrypted first route verification message based on a fifth key generated by the third node on the basis of the first identifier.

17. The network of claim 16, wherein
the third node decrypts the encrypted second route verification message based on a sixth key generated by the third node on the basis of the second identifier.

18. The network of claim 16, wherein
the third node generates an encrypted first route reply verification message, the encrypted first route reply verification message being encrypted with the fifth key, and the third node transmitting a route discovery reply comprising a description of the route from the first node to the third node and the first route reply verification message.

19. The network of claim 18, wherein
the second node receives the route discovery reply, the second node generating an encrypted second route reply verification message, the encrypted second route verification message being encrypted with the second key, and transmitting to the first node the route discovery reply, the route discovery reply being modified to include the second route reply verification message.

20. The network of claim 19, wherein the encrypted second route reply verification message is the result of the encryption, based on the second key, of the encrypted first route reply verification message, and wherein the second node replaces the first route verification message by the second route verification message in the route discovery reply.

21. The network of claim 18, wherein
the first node receiving receives the route discovery reply, and
the first node decrypts the encrypted first route reply verification message based on the third key.

22. The network of claim 21, wherein
the first node decrypts the encrypted second route reply verification message based on the second key.

23. The network of claim 10, further comprising the first node receiving a second key generated by the second node on the basis of the first identifier and comparing the first and the second keys.

24. A node having a first identifier and comprising a transceiver for communicating in a network,
the transceiver being adapted for joining the network by transmitting the first identifier to a second node having a second identifier,
for receiving an authentication message encrypted with a second key generated by the second node on the basis of the first identifier,
the node further comprising a key generator adapted for generating a first key on the basis of the second identifier
and a controller for comparing the first and the second keys with the authentication message,
the transceiver being adapted for communicating with a third node if the first and second keys are equal.
